(19) United States
(12) Patent Application Publication
(10) Pub. No.: US 2003/0037067 A1
(43) Pub. Date: Feb. 20, 2003

(54) Method and apparatus for distributing supplemental information related to articles

(76) Inventors: Jay S. Walker, Ridgefield, CT (US); T. Scott Case, Wilton, CT (US); Russell P. Sammon, San Francisco, CA (US); Stephen C. Tulley, Fairfield, CT (US); Geoffrey M. Gelman, Stamford, CT (US); James A. Jorasch, Stamford, CT (US)

Correspondence Address: WALKER DIGITAL, FIVE HIGH RIDGE PARK, STAMFORD, CT, 06905, US

(21) Appl. No.: 10/241,223

(22) Filed: Sep. 10, 2002

Related U.S. Application Data
(63) Continuation-in-part of application No. 09/422,719, filed on Oct. 22, 1999, now Pat. No. 6,449,616.
Application No. 09/422,719 is a continuation of application No. 08/729,426, filed on Oct. 11, 1996, now Pat. No. 5,995,976.

(51) Int. Cl. G06F 7/00

(52) U.S. Cl. 707/104.1

(57) ABSTRACT

A method for readers of articles in magazines, newspapers, or similar media to purchase supplemental information on portions of information in the articles from publishers that print the articles, operators of electronic databases containing the supplemental information, or third party intermediaries handling requests for supplemental information. Embedded in the midst of an article is a code that is physically positioned to identify a limited portion of information in the article. A reader may use the code to indicate further interest in supplemental information located in an electronic database, and to select a method of delivery whereby the supplemental information in the database can be delivered the reader.

### CROSS REFERENCES TO RELATED APPLICATIONS

The present application is a continuation-in-part of U.S. patent application Ser. No. 09/422,719, filed Oct. 22, 1999, issued as U.S. Pat. No. 6,449,616 on Sep. 10, 2002, which is a continuation of U.S. patent application Ser. No. 08/729,426, filed Oct. 11, 1996, issued as U.S. Pat. No. 5,995,976 on Nov. 30, 1999, all incorporated by reference herein.

### BACKGROUND OF THE INVENTION

This invention relates to electronic commerce.

Publishers of newspapers, magazines, and the like that gather and distribute information waste tremendous amounts of information daily by not distributing some of the information due to limitations on the space available for a particular article or story. They invest vast amounts of money and time in gathering the information. As the space limitations increase, however, those investments in information gathering fail to provide an adequate return because much of the information cannot be used. In other words, if the publishers cannot include information in the media for which they receive compensation from readers, they are unable to capitalize on the expenditures associated with gathering that information. There is thus a need for techniques to permit the publishers to obtain a return on the enormous investment associated with the gathering of information that they cannot currently include in the media for which they receive compensation.

Computers make it fast, easy, and inexpensive to gather and store large amounts of material relevant to a single story. As a result, most companies who collect and distribute editorial information, such as news stories, generate at great expense far more finished material than they disseminate in the “news-hole” for that particular story. It is axiomatic that the total information gathered for a given story always far exceeds the standard-length or space allocated for the distribution of the story. Writers, and more frequently editors, must cut and condense each story in a never ending battle to make it fit within the finite amount of available space. The space can take the form of air time, as is the case for TV and radio, or column inches on a printed page, as is the case with magazines, newspapers, newsletters, whether or not online or actually printed on paper.

Information gathered and not published for a given story can best be characterized as surplus information. For typical news media, such surplus information has little or no value, beyond possibly storing a portion of such information in an archive for possible future use.

### BRIEF DESCRIPTION OF THE DRAWINGS

FIG. 1 is a block diagram of an information distribution system according to an embodiment of the present invention;

FIG. 2 is a block diagram of the components of a central controller used by the information distribution system of FIG. 1;

FIGS. 3a-d illustrate the fields of embodiments of an information database, a hyper-footnote database, a supplemental information database, and a user information database of the central controller used by the information distribution system;

FIG. 4 is a flow chart of an operation of the information distribution system to process requests for supplemental information;

FIGS. 5a and 5b is a flow chart of a procedure used by the central controller to process requests for supplemental information;

FIG. 6 is a flow chart of a procedure used by the central controller to compute a hyper-footnote corresponding to requested supplemental information;

FIG. 7 is a flow chart of a procedure used by the central controller to transmit requested supplemental information; and

FIG. 8 is a flow chart of a procedure used by the central controller to obtain payment for requested supplemental information.

### DETAILED DESCRIPTION

Reference will now be made in detail to an implementation of the present invention illustrated in the accompanying drawings. Wherever possible, the same reference numbers will be used throughout the drawings and the following description to refer to the same or like parts.

Standard components preferably include conventional computers, telecommunications services, and input and output devices such as telephones, computer terminals, printers, and facsimile machines. The architecture and procedures to implement data handling among these machines, however, are not conventional, as they provide for distribution of supplemental information corresponding to portions of articles.

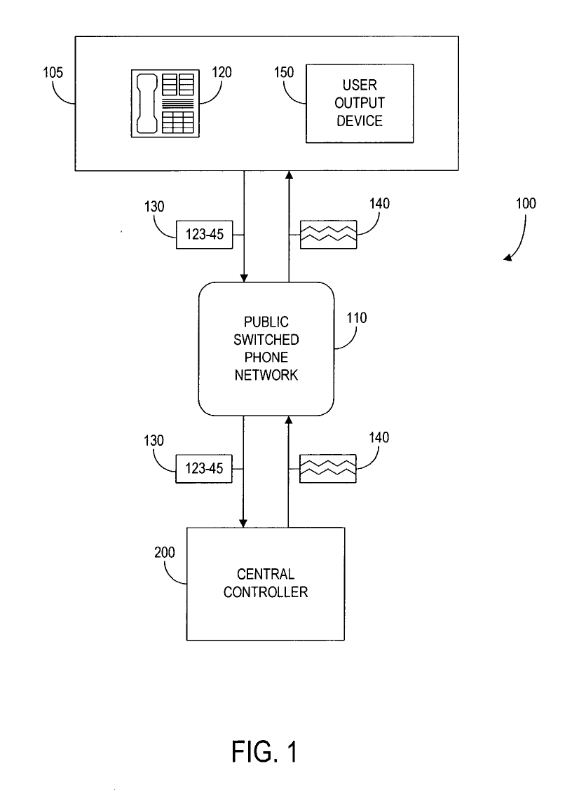

FIG. 1 is a block diagram of information distribution system 100 according to an implementation of the present invention. As illustrated, system 100 includes user location 105, a network 110 such as a public switched telephone network, and central controller 200. User location 105 includes a user input device 120, which, as illustrated, may be a telephone, computer, or similar device (e.g., PDA, cell phone, pager). User location 105 also includes a user output device 150, which, as illustrated, may be a printer. Those skilled in the art will recognize that user input device 120 may be any electronic input device connectable to central controller 200, such as a computer with a modem for connecting to central controller 200 via network 110. Similarly, user output device 150 may be any type of output device such as a computer terminal, facsimile machine, etc. Output device 150 also represents an e-mail address, website, or the like, to which central controller 200 may send requested information.

If used, a public switched telephone network may be a conventional public switched telephone network of the type operated by telephone companies like MCI, AT&T, NYNEX, Bell Atlantic, etc.

Lastly, central controller 200 includes a conventional server computer system, that responds in near real-time to requests for stored information. Central controller 200 also executes software to store and manage supplemental information related to portions of information found in, for example, articles, and to distribute the stored supplemental information upon request.

As shown in FIG. 1, a user transmits a request using user input device 120. The request initiates a process to locate, retrieve, and transmit to the user supplemental information related to a portion of information found in an article. The request includes a hyper-footnote 130, in this case “123-45.” The request may be transmitted in a variety of ways. For example, a user may use known means to activate or click on a button, hyperlink or other element of a web page, such as a hyperlink that represents the footnote “123-45”. Similarly, a user may press a button on a cell phone that corresponds to selection of a desired hyperlink.

As used herein, hyper-footnote means a code or other indicator identifying a limited portion of information in the article for which supplemental information exists. The code may be printed or embedded in the midst of an article, or as described more fully herein below it may be otherwise discernable or calculable by a reader. Such articles may be printed on a physical medium such as paper, or displayed via a computer or similar technology, such as text in a browser.

A single area of text within an article may have multiple corresponding hyper-footnotes. Each corresponding hyper-footnote might present supplementary information from a different perspective. For example, a sports article may describe a noteworthy play in a football game, and the description of that play has two hyper-footnotes. One hyper-footnote leads to supplementary information from an interview with a player from team A. The other hyper-footnote leads to an interview with a player from team B. Both players may have been involved in the play, but have different perspectives to share.

Publishers of articles either embed hyper-footnotes in the articles next to related portions of information or designate portions of information as corresponding to hyper-footnotes. To designate portions of information as corresponding to hyper-footnotes, publishers may alter the appearance of a portion of information in the articles. This altered appearance signals a hyper-footnote for supplemental information related to the portion of information.

Central controller 200 receives the user's request, including hyper-footnote 130, via network 110. Central controller 200 determines whether any supplemental information 140 corresponding to the received hyper-footnote 130 exists. If so, central controller 200 retrieves the requested supplemental information from a supplemental information database, and sends the retrieved supplemental information 140 to a user-specified location, such as user output device 150. Those skilled in the art will recognize that user input device 120 and user output device 150 may be at different locations, in which case the request transmitted to central controller 200 would include an identity and/or location of user output device 150 to which supplemental information should be sent. Additionally, as discussed below, users pre-register with central controller 200 before it will provide requested supplemental information. As part of the registration process, the users may specify a preferred output device to which central controller 200 will transmit any requested supplemental information.

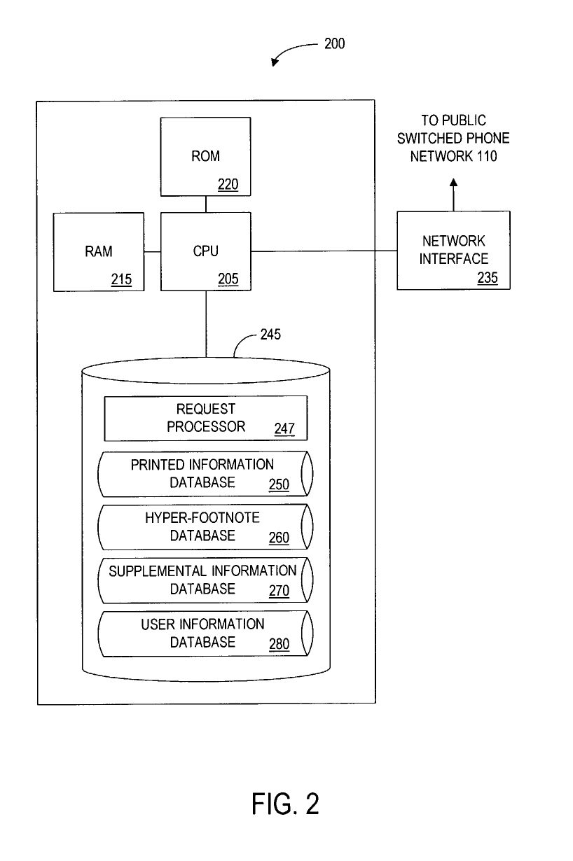

FIG. 2 is a block diagram of the components of central controller 200. Central controller 200 is connectable to a conventional network interface device 235, to connect central controller 200 to public switched telephone network 110. At the heart of central controller 200 is CPU 205. CPU 205 connects to RAM 215, ROM 220, and storage device 245. CPU 205 represents one or more microprocessors such as the Pentium® processor manufactured by Intel Corporation. RAM 215 and ROM 220 are also conventional. CPU 205, RAM 215, and ROM 220 are used in conventional ways to process requests for supplemental information in accordance with stored instructions, i.e., computer software.

Storage device 245 is a conventional mass storage device such as a hard disk. It may also include multiple mass storage devices, including both read-write devices and write-once read many times devices like optical disk drives. Storage device 245 includes a request processor 247 and multiple databases 250-280.

Request processor 247 constitutes computer software executed by CPU 205 for processing the requests for supplemental information related to a portion of information found in an article. Using information maintained by databases 250-280, CPU 205 processes requests for supplemental information in accordance with instructions of request processor 247.

Storage device 245 also includes a printed information database 250, a hyper-footnote database 260, a supplemental information database 270, and a user information database 280. Databases 250-280 may include various types of database structures. The preferred database structure is a relational database because it provides rapid responses to requests for supplemental information.

In general, printed information database 250 holds information on articles, including hyper-footnotes related to portions of information of the articles for which supplemental information exists. Hyper-footnote database 260 includes a listing of hyper-footnotes and corresponding supplemental information identifiers used to locate corresponding supplemental information in the supplemental information database 270. Supplemental information database 270 stores the supplemental information corresponding to portions of information in articles. Lastly, user information database 280 contains information on registered customers who have registered to receive supplemental information.

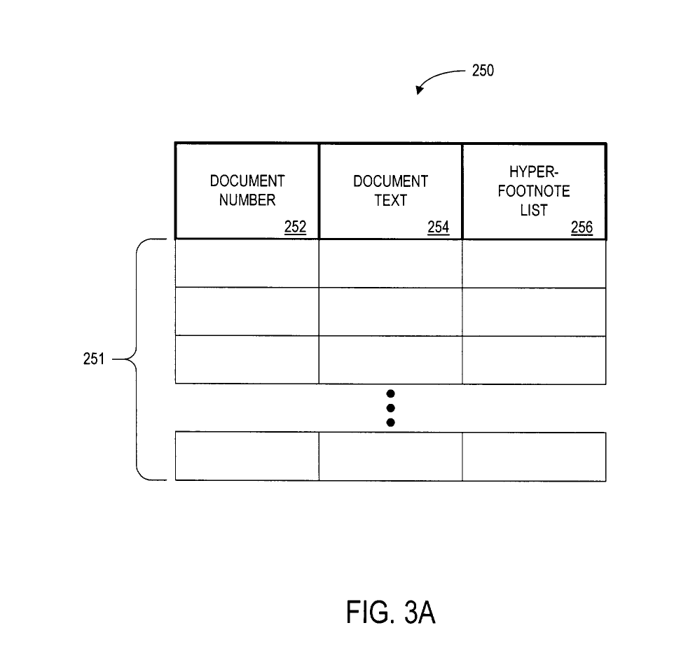

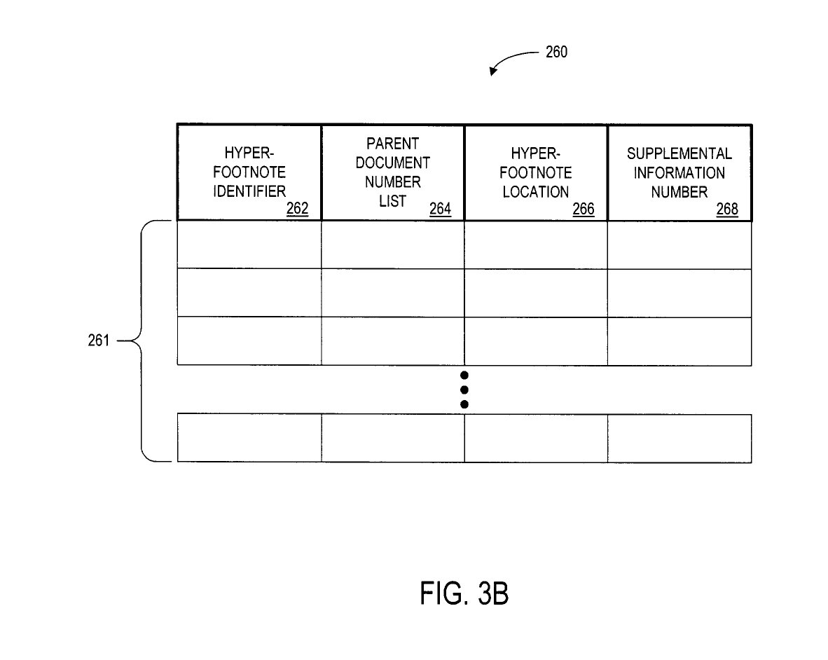

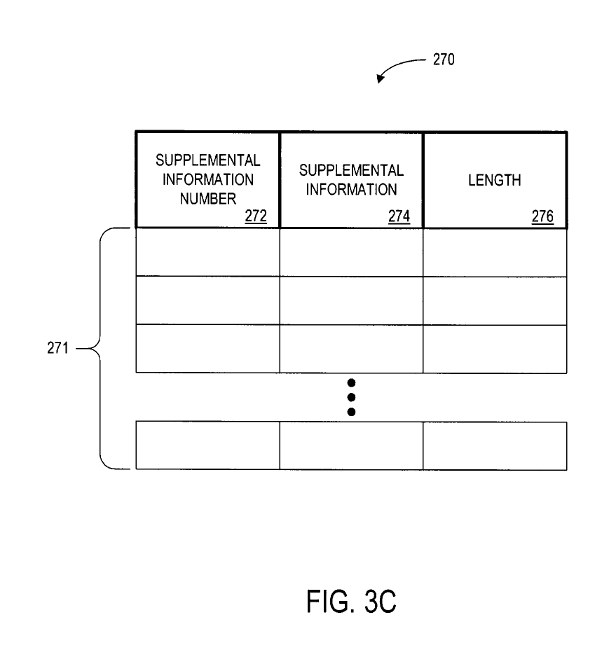

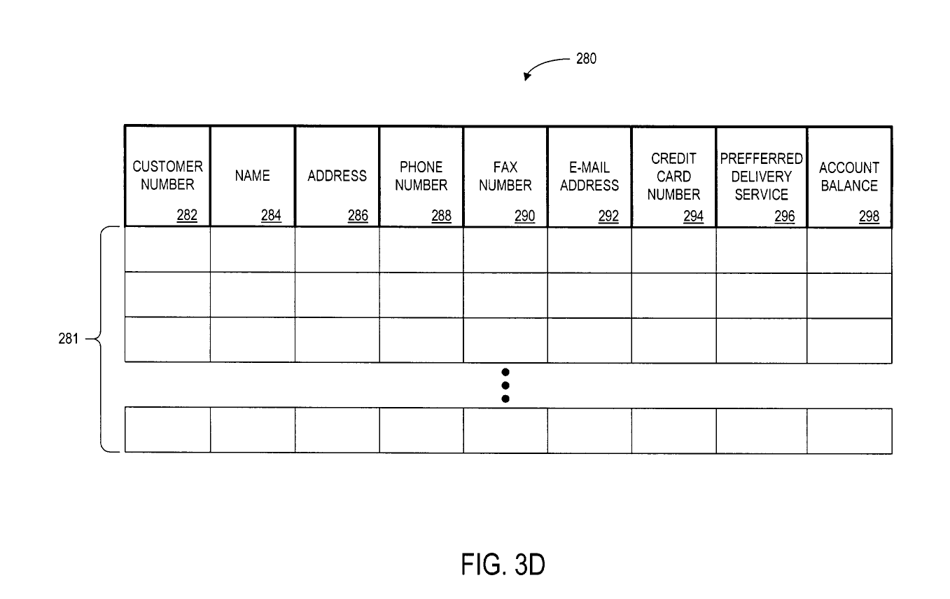

FIG. 3a illustrates the fields of printed information database 250. FIG. 3b illustrates the fields of the hyper-footnote database 260. FIG. 3c illustrates the fields of supplemental information database 270. FIG. 3d illustrates the fields of user information database 280 that information distribution system 100 uses to locate and distribute supplemental information and to collect payment for the distribution of supplemental information.

Printed information database 250 in FIG. 3a includes records 251 preferably having three fields: (1) document number 252, (2) document text 254, and (3) hyper-footnote list 256. Document number 252 is a unique alphanumeric used to identify a document that has been printed and for which additional or supplemental information exists. Document text 254 is the text of the document that has been printed. Hyper-footnote list 256 is a listing of one or more hyper-footnotes corresponding to supplemental information related to portions of the document.

Hyper-footnote database 260 in FIG. 3b includes records 261 preferably having four fields: (1) hyper-footnote identifier 262, (2) parent document number list 264, (3) hyper-footnote location 266, and (4) supplemental information number 268. Hyper-footnote identifier 262 is a unique alphanumeric used to identify each hyper-footnote. Hyper-footnote identifiers are found in the hyper-footnote list 256 for each document record 251 specified in the printed information database 250.

Parent document number list 264 includes document numbers 252 for records 251 of printed information database 250 corresponding to each of the hyper-footnotes in database 260. One hyper-footnote record 261 may relate to one or more document records 251 and vice versa. Hyper-footnote list 256 for each document record 251 relates hyper-footnote records 261 to document records 251. Parent document number list 264 for each hyper-footnote record 261 relates document records 251 to hyper-footnote records 261.

Hyper-footnote location 266 for each hyper-footnote record 261 indicates the location, such as page number and line number, of the hyper-footnotes within the document text field 254 of a document record 251 of printed information database 250. Finally, supplemental information number 268 is a unique identifier corresponding to each hyper-footnote record 261 and specifying an entry 271 in supplemental information database 270.

Supplemental information database 270 in FIG. 3c includes records 271 preferably having three fields: (1) supplemental information number 272, (2) supplemental information 274, and (3) length of the supplemental information 276. Supplemental information number 272 for each record 271 of supplemental information database 270 is a unique alphanumeric identifier corresponding to each entry 271. Identifier 272 is used to locate supplemental information corresponding to hyper-footnotes in supplemental information database 270. In addition to unique identifier 272, each supplemental information record 271 of database 270 includes supplemental information 274 as well as its length 276. In addition to text, supplemental information field 274 may contain audio, video, or another form of supplemental information to the text of a document. The length for each field 274 is used, for example, for output control and, if so configured, for determining the cost of providing the supplemental information in response to requests. Price charged for each entry may also be stored.

Prices charged could depend on, e.g., the number of words, medium (audio vs video vs print), subject matter, and popularity of the article. Also, when a user desires to purchase supplementary information for a single article, the controller could instead offer to sell that user a package (e.g. access to supplementary information on any five articles). The price of the package may be more than the price of viewing supplementary information for a single article, but for less than the price of viewing supplementary information for five articles.

Further, prices charged for the same information may not be the same for all users. For example, earlier users of particular information may be charged a lower price than subsequent users.

Prices for information may also be determined by bidding. In one embodiment, a user's bid for supplemental information determines the amount of information provided. Similarly, the bid amount may affect the timing of information delivery (e.g., higher bidders receive the information sooner than lower bidders).

Supplementary information in supplemental information database 270 may be erased after a set period of time. For example, three days after the corresponding article has been published, the supplemental information may be erased in order to save space in the database, or to promote earlier sales of such supplemental information.

Finally, user information database 280 in FIG. 3d includes records 281 preferably having nine fields: (1) customer identification number 282, (2) customer name 284, (3) customer address 286, (4) customer telephone number 288, (5) customer facsimile telephone number 290, (6) customer e-mail address 292, (7) credit card type and number 294, (8) preferred delivery means 296, and (9) account balance 298. Customer identification number 282 is a unique identifier corresponding to each customer registered to receive supplemental information upon request. Name field 284 holds the name of the customer and address field 286 holds the customer's street address. Phone number field 288 is for each customer's telephone number, and fax number field 290 is for a separate telephone number dedicated for a facsimile machine, if available. E-mail address field 292 is for the customer's e-mail address, if available, and credit card number field 294 is for the customer's credit card type and number.

Preferred delivery service field 296 is for the customer's selected method to receive requested supplemental information. Such methods may include, for example, regular mail, or a faster courier service such as FedEx, DHL Courier, etc. Facsimile and e-mail are additional methods for delivering requested supplemental information. Another available delivery method is to send any requested supplemental information to an address on the World Wide Web.

Lastly, each record 281 includes account balance field 298. If the customer has requested, for example, invoice billing, account balance field 298 may be used to bill the customer. Alternatively, account balance field 298 may be used to bill the customer's credit card by sending a payment request to the appropriate credit card processing company.

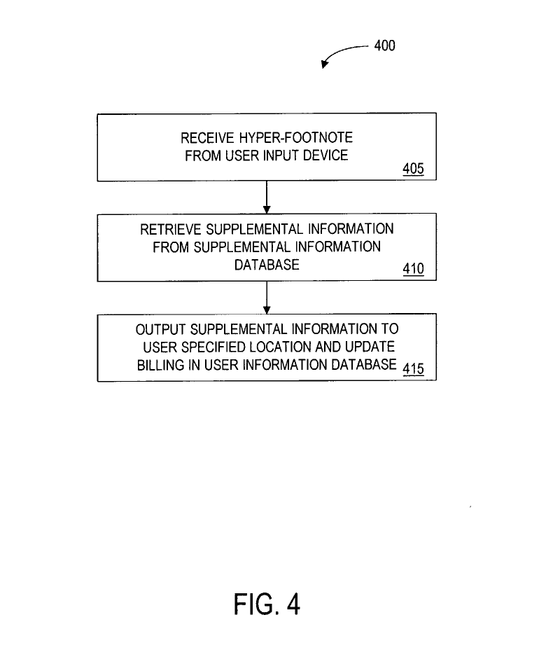

FIG. 4 is a flow chart of the general procedure 400 used by central controller 200 to provide supplemental information using databases 250-280. The particular arrangement of elements in the flow chart, as well as the other flow charts discussed herein, is not meant to imply a fixed order to the steps; embodiments of the present invention can be practiced in any order that is practicable. Central controller 200 first receives a request for supplemental information from a user input device such as a telephone or computer (step 405). The request includes a hyper-footnote from a print media. Central controller 200 uses the input hyper-footnote to retrieve any supplemental information from supplemental information database 270 (step 410). Central controller 200 then outputs the located supplemental information to a specified user output device (step 420). The output device may be specified by the user as part of the initial request for supplemental information or an output device specified for the user in user information database 280. Further, central controller 200 updates billing information in user information database 280 to reflect the “purchase” (transmission) of requested supplemental information (step 420).

In one embodiment, the central controller 200 may monitor and record the number of times users request particular hyper-footnotes. Based on such information, more of such information or such types of information may be provided in the future. For example, if there is are many clicks on a hyper-footnote leading to more information on Billy Joel's mansion, then more supplementary information might be provided for his mansion in the future. In fact, the supplementary information may be made into its own feature article if there is enough interest.

In one embodiment, the central controller 200 may monitor and record the number of times users attempt to access something that is not a hyper-footnote. The controller may use such information to, e.g., suggest necessary changes to the display or format of information to users.

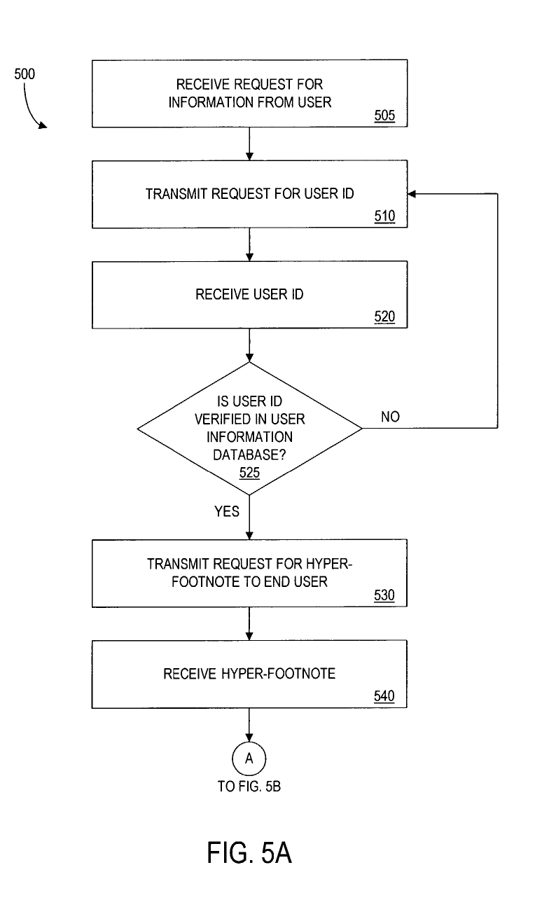

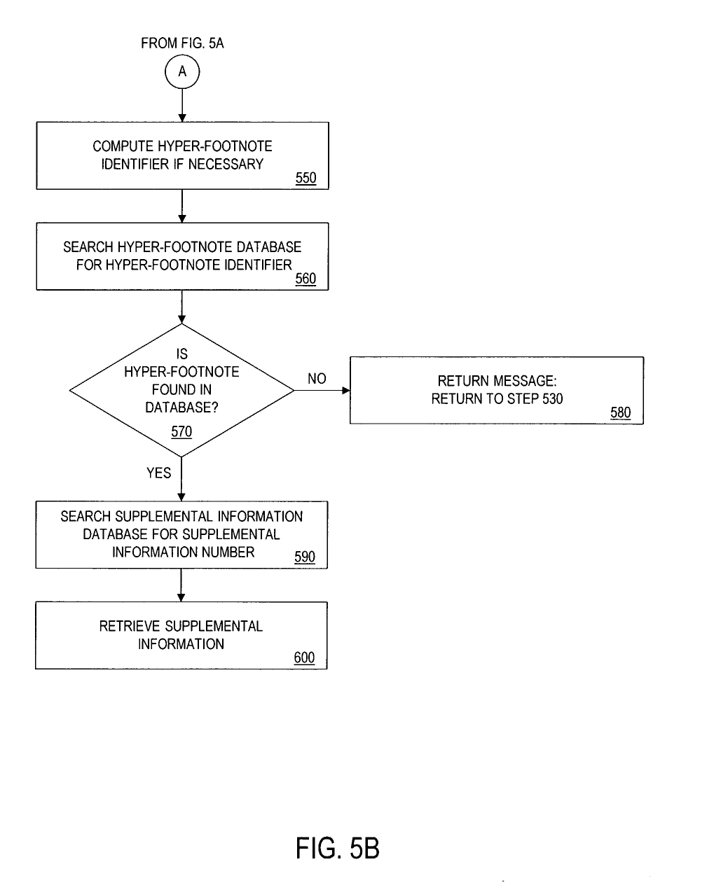

FIGS. 5a and 5b illustrate a more detailed flow chart of the procedure 500 used by central controller 200 executing the software of the request processor 247 to process requests for supplemental information. After a service customer connects input device 120 to central controller 200 via network 110, central controller 200 recognizes this connection as a request for supplemental information from the user (step 505), and then prompts the user for a user identification number (step 510). With certain input devices, such as telephones, users can input a user identification number using either a number pad or voice input.

After central controller 200 receives the user's identification number (step 520), it determines whether the received number corresponds to a number in user information database 280 (step 525). If not, then central controller 200 prompts the user again for a user identification number (step 510). This process is repeated a predetermined number of times or until the user provides the proper identification number, which ever occurs first. If the predetermined number of times for prompting the user for an identification number is reached, then central controller 200 disconnects the user's input device.

After the user provides a proper customer identification number (step 525), central controller 200 prompts that user for a desired hyper-footnote corresponding to a portion of a document (step 530). Central controller 200 then receives the desired hyper-footnote from the user (step 540). This process may time out if the user waits too long before responding to any of the prompts for input. If the process times out, then the user's connection to central controller 200 will be disconnected.

The desired hyper-footnote may be a code embedded in the text of the article or a portion of the article itself. In the latter situation, the hyper-footnote may be represented in the article in a variety of different ways. When using a method other than embedded codes to indicate the existence of a hyper-footnote, it may also be necessary to provide further information in the article, for example, a number identifying the article as well as the line number corresponding to the portion constituting a hyper-footnote.

The following text shows two different types of hyper-footnotes:

1 Winston Churchill was an extraordinary man.[125]

2 His contributions to history are well documented in

3 a number of texts and his sense of humor has been

4 recounted by numerous historians.

In this example, the number 125 in the brackets [] represents one type of hyper-footnote that may appear in an article, and the underlined and italicized phrases are another type of hyper-footnote. The underlined and italicized phrases are examples of the type of hyper-footnote where text is altered to distinguish the phrase to which corresponding supplemental information exists from the remaining text of the article. The first type of hyper-footnote represents general information available on Mr. Churchill. The second refers to information detailing Mr. Churchill's contributions to history, and the third refers to stored audio and/or video of an author discussing a humorous story concerning Mr. Churchill. In all three cases, the information referred to by the hyper-footnotes constitutes supplemental information available through the central controller 200.

Different types of hyper-footnotes may be used to distinguish between different types of supplemental information such as textual, audio, or video information. Thus, by viewing the particular hyper-footnote, the reader may determine whether the available supplemental information is text, audio, video, or some other form. In addition, different types of hyper-footnotes may be used to distinguish between other features, such as different prices of the corresponding information. For example, one color or formatting (e.g., italics) may be used to denote information which costs less than one dollar, and another color or formatting (e.g., underlining) may be used to distinguish information which costs more than one dollar.

Similarly, the same article may be footnoted in different ways for different customers. For example, in an embodiment of the invention, a premium customer may have more hyper-footnotes interspersed in his article than does a non-premium, customer, although the article read by the two customers may be the same. The hyper-footnote for the premium customer may access the same information, but may indicate that the information is cheaper.

Similarly, certain users may have access t certain supplemental information that is not available to other users.

For the second and third example hyper-footnotes, request processor 247 computes a hyper-footnote. For example, the user would identify a hyper-footnote as a combination of an article number and the number of the line of the text for which supplemental information exists. Therefore, after the user inputs a request for a desired hyper-footnote, central controller 200 computes the hyper-footnote identifier, if necessary (step 550). Then, central controller 200, operating under the instruction of request processor 247, searches in hyper-footnote database 260 for the hyper-footnote (step 560), and determines whether the hyper-footnote was in database 260 (step 570). If not, request processor 247 generates and outputs to the user a message indicating that the input hyper-footnote could not be located in database 260, and the process prompts the user for another hyper-footnote (step 580 and step 530). If so, central controller 200 searches supplemental information database 270 for the supplemental information number found in database 260 and corresponding to the input hyper-footnote (step 590), and retrieves the stored supplemental information corresponding to the hyper-footnote (step 595).

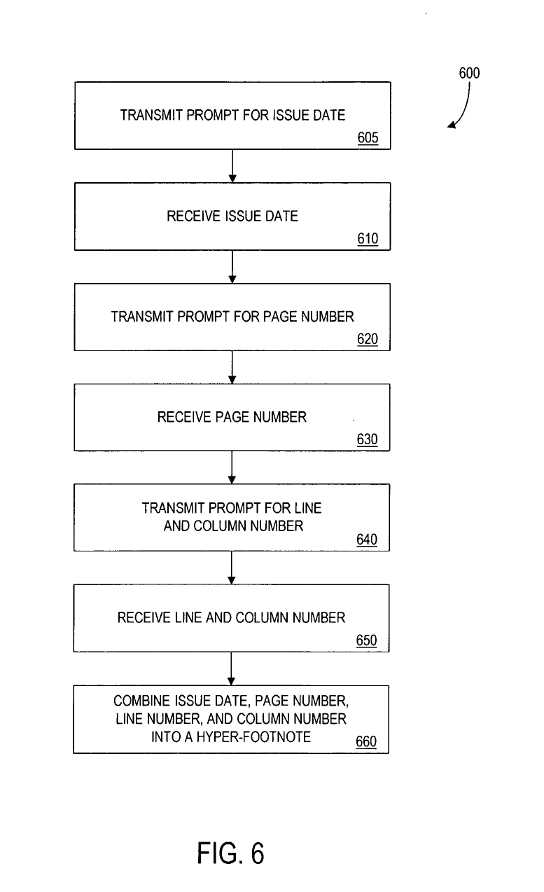

FIG. 6 is a flow chart of a preferred procedure 600 used by central controller 200 to compute a hyper-footnote corresponding to requested supplemental information when the hyper-footnote may not be embedded or printed with the rest of a document.

Central controller 200 prompts the user for an issue date corresponding to the issue of the document containing the desired hyper-footnote (step 605). After central controller 200 receives the issue date (step 610), it prompts the user for a page number of the document containing the desired hyper-footnote (step 620), and receives that number (step 630).

Central controller 200 prompts the user for a column and/or line number for the hyper-footnote (step 640), and receives this information (step 650). Finally, central controller 200 combines the information to generate a hyper-footnote that may be found in database 260. The hyper-footnote may be identified by an identifier that is simply the concatenation of the issue date, page number, column number, and line number, or it may be computed based on some other combination of this information.

Using the example specified above, the user may provide an issue date for The New York Times Magazine that included an article on Winston Churchill and the specific passage discussed above. Those skilled in the art will recognize that there are alternative methods to represent hyper-footnotes in the text of an article without embedding the code itself in the article. This description of a method for calculating hyper-footnotes is not intended to limit the present invention to only that method; rather, it is intended to illustrate an exemplary method to represent hyper-footnotes.

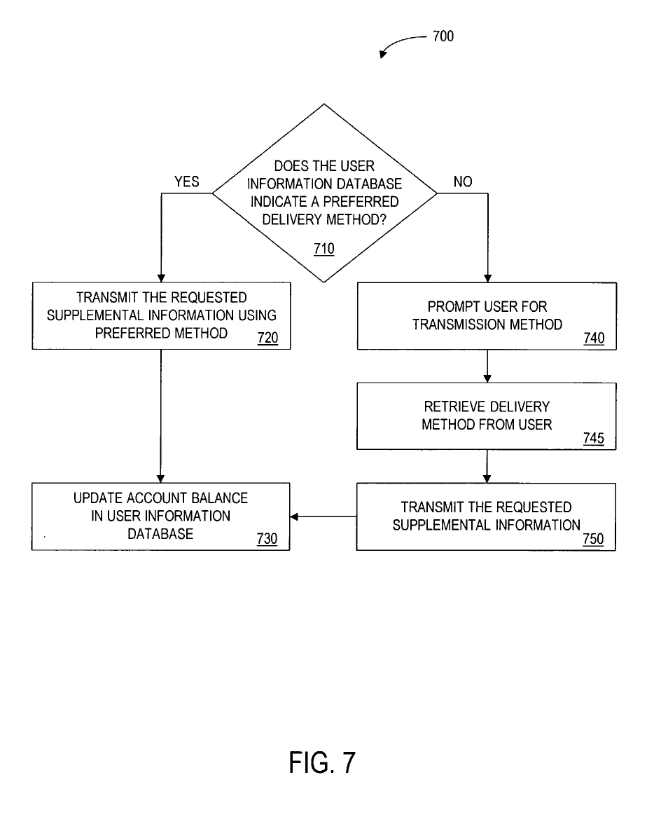

After the requested hyper-footnote is referenced, the request processor 247 preferably implements a software procedure 700 (FIG. 7) to transmit requested supplemental information to the user and bill the customer for the requested information. Using the customer identification number provided by the user when requesting supplemental information, central controller 200 determines whether the user has selected a preferred method for receiving requested supplemental information (step 710). If so, central controller 200 transmits the requested supplemental information using the selected method (step 720). Otherwise, central controller 200 prompts the user for a delivery method (step 740), references details about the method from the user, and then transmits the supplemental information using the selected method (step 750).

In either case, as a last step central controller 200 updates the account balance in the user's account balance in user information database 280 to reflect the transmission of requested supplemental information (step 730).

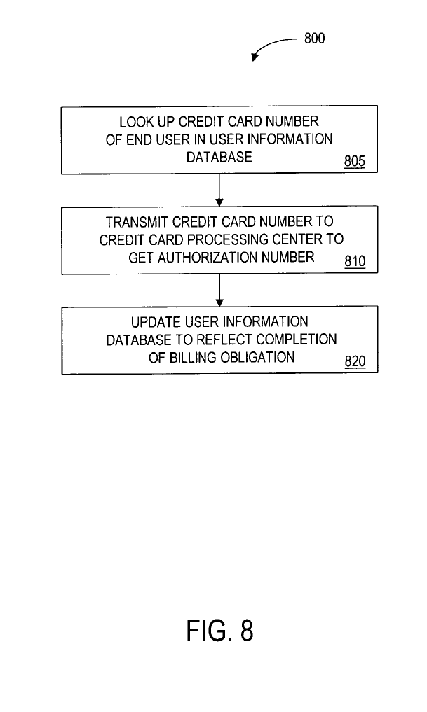

FIG. 8 is a flow chart of a procedure 800 used by central controller 200, under instruction of the request processor 247, to process payment for requested supplemental information using a conventional credit card transaction. Using the customer identification number, central controller 200 looks up the corresponding credit card number in user information database 280 (step 805). Central controller 200 then transmits the credit card number to an appropriate credit card processing center for an authorization number (step 810).

Central controller 200 connects to the credit card processing center via public switched telephone network 110. Assuming authorization is received, central controller 200 then updates the user account balance corresponding to the customer identification number of user information database 280 to reflect completion of the billing obligation (step 820). The credit card processing center compensates the supplier of supplemental information for the transmission of requested information to a user, and bills the user as part of its billing procedures.

Alternative billing methods may be used as well, without detracting from the scope of the present invention. For example, central controller 200 may, at periodic intervals, review the account balance fields 298 for records in user information database 280 to determine whether any accounts have balances that should be billed. For these accounts, central controller 200 would generate bills to be sent to the customers at the appropriate addresses specified in the user information database 280.

The present invention thus provides a practical and economically feasible system for publishers to sell to their readers valuable supplement information, which is often developed in the routine process of business but otherwise wasted, related to information found in print material. This is accomplished by providing readers with hyper-footnotes, a simple means to identify whether supplemental information exists, and a mechanism to communicate with a central controller to obtain the supplemental information corresponding to the hyper-footnotes.

The following are examples which illustrate additional embodiments of the present invention. These examples do not constitute a definition of all possible embodiments, and those skilled in the art will understand that the present invention is applicable to many other embodiments. Further, although the following examples are briefly described for clarity, those skilled in the art will understand how to make any changes, if necessary, to the above-described apparatus and methods to accommodate these and other embodiments and applications.

According to an embodiment of the present invention, a news organization with supplementary information that is ‘off the record’ may make it available under certain circumstances. For example, it may be made available if enough people express interest in listening to the off-the-record material, or if people are willing to pay a high enough price. Making such information available may require the news organization to convince the source to allow the material on the record again. Consequently, even material that is provided off the record may come on the record conditioned upon enough demand. In some embodiments, the source of the information may be paid for the information, or based on the demand or orders for the information.

In an embodiment, third-party sources may be allowed to provide supplementary information to which hyper-footnotes link. For example, a reader may enter a hyper-footnote via the controller's Web site, prompting the reader to be directed to a third party Web site having supplementary information related to that hyper-footnote. Third-party sources may then split any revenue from the purchase of the supplementary information with the news organization. Alternatively, the third-party sources may be promoting some product, in which case the third party sources might pay for the privilege of providing the information. For example, there is an article on Vioxx, and a hyper-link related to Vioxx connects the user to an information Web site talking about Vioxx. Merck might pay for the privilege of providing the information Web site.

Ordering and delivery of supplemental information might be accomplished through different media. For example, a user may request supplemental information via a cell phone, but that information might later be delivered on a tangible printed medium or as an email message.

A hyper-footnote could be used on a label of a food product. Accessing that hyper-footnote provide the user with recipes that use that food product or a similar food product. A hyper-footnote may also be used on product catalogs for information regarding specific product. A hyper-footnote may also be used on billboards to provide information such as a local road atlas or advertisements for local businesses.

Hyper-footnotes could be used on a television program schedule to provide a preview of a movie upon entering a code. Such a service could be incorporated into a set-top box of a television.

Hyper-footnotes could be used on a restaurant menu provide information such as whether particular food products contain peanuts or other potential allergens. Similarly, a wireless transmitter may be included on certain products to provide a warning whether potential allergens are included in the product.

Hyperfootnotes on a printed medium may be printed in invisible ink, and a special light (e.g., a black light) may be used to reveal that information. In one embodiment, upon rendering payment, the user is informed of the appropriate light frequency to use to reveal the information.

Hyper-footnotes could be used on a contract to provide information regarding terms of a contract or a “message board” where people may record, e.g., complaints about particular clauses.

A user may request all hyper-footnotes related to an article or set of articles (e.g., in an entire magazine). The corresponding supplementary information could, e.g., be printed for the user, and possibly provided for the user in his next issue (e.g., of a magazine subscription). Similarly, a user may ‘check off’ boxes on a postcard indicating what supplementary content is desired, and mail the postcard to initiate the request.

Supplementary information relating to a page being viewed by a user, or related to the most important topic on that page, could be automatically sent or provided to a user. Such automatic delivery could be initiated after, e.g., the user has been looking at a page for more than a predetermined amount of time. Such automatic delivery could also be initiated after, e.g., the user accesses a certain type or number of pages.

Content which is provided to a user may be customized based on, e.g., the user's demographic information such as whether a child or adult, whether male or female, whether rich or not, whether single or married. For example, if a user is known to be a New York Mets fan, that user could be provided with supplemental information which has a slant in favor of the Mets rather than a slant in favor of an opposing team.

Using a cell phone or other computing device, a user could request supplementary information before buying a particular magazine.

Inserts located in a magazine (a postcard which can be torn out or otherwise taken by a user form the magazine) may contain codes granting the user right to content (e.g., one thousand images free). Such content may be provided on a medium accompanying the magazine (e.g., a CD) or may be provided on a web site.

The subscriber version of a magazine could include hyper-footnotes not include in newsstand versions of the magazine. Inserts in the newsstand versions could allow a user to obtain such supplementary content.

Hyper-footnotes could be provided on the back of a printed store receipt. Accessing the hyper-footnote could provide, e.g., ten seconds of content using the display at a POS terminal to display video. Delivery of video may be contingent on payment for a particular product.

To hinder copying of supplemental information, electronic information may be combined with printed information. For example, part of the information may be printed on a medium (e.g., a magazine tear-out), and such a part contains many gaps. The other pieces of the information are sent electronically. A printer than fills in the gaps on the printed medium by printing the electronically-sent information onto the printed medium to fill in the gaps thereon. Both the printed and electronic information are preferably not useful without the other because each only represents partial information.

In an embodiment, all hyper-footnotes are unique and may be used only once. Thus, copying is reduced because a hyper-footnote cannot be used by more than one person.

Greeting cards may include hyper-footnotes. The hyper-footnote can provide the recipient of the card with personalized a message.

The foregoing description of an implementation of the invention has been presented for purposes of illustration and description. It is not intended to be exhaustive or to limit the invention to the precise form disclosed. Modifications and variations are possible in light of the above teachings or may be acquired from practice of the invention. The scope of the invention is defined by the claims and their equivalents.

What is claimed is:

1. A method comprising:
receiving from a user an indication of a code representing supplemental information that is not present in a printed article read by the user;
determining a price of the supplemental information based on characteristics of the user; and
delivering the supplemental information to the user.

2. A method comprising:
receiving from a user, via a first Web page, an indication of a code representing supplemental information that is not present in a printed article read by the user;
selecting a record from a plurality of records based on user characteristics, each record representing supplemental text related to the printed article; and
delivering the supplemental information to the user via a second Web page.

3. A method comprising:
receiving from a user an indication of a code representing supplemental information that is not present in a printed article read by the user;
delivering the supplemental information to the user; and
registering the code as invalid, thereby preventing further accesses of the supplemental information using the code
